(19) United States
(12) Patent Application Publication
(10) Pub. No.: US 2019/0042656 A1
(43) Pub. Date: Feb. 7, 2019

(54) SCORING OF INTERNET PRESENCE

(71) Applicant: Dennis Mark Germishuys, Irene (ZA)

(72) Inventor: Dennis Mark Germishuys, Irene (ZA)

(21) Appl. No.: 16/075,197

(22) PCT Filed: Feb. 3, 2017
(86) PCT No.: PCT/IB2017/050586

§ 371 Date: Aug. 3, 2018

(30) Foreign Application Priority Data
Feb. 3, 2016 (ZA) 2016/00768

(51) Int. Cl. G06F 17/30; G06F 17/28

(52) U.S. Cl. CPC G06F 17/30867; G06F 17/28; G06F 17/30522; G06F 17/30554

(57) ABSTRACT

A method of allocating a score to a subject's Internet presence, the method including receiving search terms of a subject whose Internet presence is to be scored, conducting Internet searches using the search parameters, assessing the preliminary search results to confirm that the preliminary search results exceed a predefined minimum match threshold with the search terms, compiling final search results from the preliminary search results that exceeds the predefined minimum match threshold, compiling the final search results in a structured database, assessing the text of the final search results in the structured database in relation to a set of predefined assessment criteria, allocating a score to each element in the set of predefined assessment criteria according to a predefined scoring scheme and compiling a final score of a subject's presence on websites by collating the scores of each of the elements in the set of predefined assessment criteria.

### FIELD OF THE INVENTION

This invention relates to the scoring of Internet presence. In particular, the invention relates to a method of allocating a score to a subject's Internet presence and to a social media presence analysis system.

### BACKGROUND OF THE INVENTION

The inventor is aware of social media applications that can be used to categorize a user's social media usage. However, none of the social media applications provides a method to associate a risk profile to a user's social media activities. Such a risk profile would be useful to rate a user's risk for entering onto certain types of transactions, be it commercial transactions, employment agreements, or the like.

### SUMMARY OF THE INVENTION

According to a first aspect of the invention, there is provided a method of allocating a score to a subject's Internet presence, the method including

receiving search terms of a subject whose social media presence is to be scored;

conducting internet searches using the search parameters to compile preliminary search results of websites (including social media sites) on which the search parameters appear;

assessing the preliminary search results to confirm that the preliminary search results exceed a predefined minimum match threshold with the search terms;

compiling final search results from the preliminary search results that exceeds the predefined minimum match threshold;

compiling the final search results in a structured database;

assessing the text of the final search results in the structured database in relation to a set of predefined assessment criteria;

allocating a score to each element in the set of predefined assessment criteria according to a predefined scoring scheme;

compiling a final score of a subject's social media presence by collating the scores of each of the elements in the set of predefined assessment criteria.

The websites searched may include social media sites and the final score of the subject's presence on websites may include the subject's presence on social media sites. The subject's Internet presence thus includes the subject's social media presence.

Receiving search terms on a subject whose social media presence is to be assessed may include receiving usernames of a subject's social media accounts. Alternatively receiving search terms on a subject whose social media presence is to be assessed may include compiling a list of social media search terms based on a subject's personal details. The personal details may include the subject's name, surname, nicknames, employer, interests, hobbies, country, people and organizational associates, profession current and past, location and the like.

Conducting internet searches using the search terms to compile preliminary search results of websites may include employing web crawlers, RSS feeds and Application program interfaces (API's) systematically to return text found on the Internet which includes the search terms that are searched.

The method may include translating the final search results from a foreign language into the English language. This step may include detecting the foreign language and then applying a translation application to translate the text from the foreign language into English.

Assessing the preliminary search results to confirm that the preliminary search results exceeds a predefined minimum match threshold may include comparing the text found with the set of search terms searched for and compiling a correlation score between the search terms and the search results.

The set of predefined assessment criteria may include the ideology of the subject, the tone used by the subject, the emotional expression of the subject, the language used by the subject, the associations of the subject, the interests of the subject.

Compiling the final search results in a structured database may include arranging the text of the search results into fields in a database. For example, the structured database may contain the following fields: an unique system identifier, source where the information was found, subject identifier, information extracted from the source, ideology allocated to the subject, an emotional score of the subject, a language usage score, entities or individuals with which the subject is associated, a tone that the subject uses, interests of the subject, and the like.

Assessing the text of the final search results in the structured database in relation to a set of predefined assessment criteria may include categorizing the language used in the text into a number of predefined alternatives for at least some of the fields in the database. For example the source where the information was found may include: news feeds, blogs, forums, websites, radio, social media sites, and the like. The subject identifier may include: a name, social media account, identity number, physical address, mobile number, employer details, and the like. The ideology allocated to the subject following analysis of the text may include: right wing, conservative, left wing, mixed ideology, Christian, communist Nazi, anti-EU, American Baptist, Anti-corruption, and the like. The emotional score of the subject may include: happy, sad, nervous, worried, cross and the like. The language usage score may include: foul, offensive, profanity, bad words, swear words, political, sexual, racial and the like. The tone that the subject uses may include: appreciative, ardent, arrogant, bitter, compliant, critical, confused, condescending and the like. The interests of the subject may include: aircraft spotting, airbrushing, airsoft, acting, aeromodelling, amateur astronomy, amateur radio, animals/pets/dogs, archery, soccer, judo, base jumping, basketball beach/sun tanning, beachcombing and the like.

Allocating a score to each element in the set of predefined assessment criteria according to a predefined scoring scheme may include allocating a numerical value to the results of each element in the set of predefined assessment criteria.

Allocating a score to each element in the set of predefined assessment criteria may include associating a weight to each element of the predefined assessment criteria.

Compiling a final score of a subject's social media presence by collating the scores of each of the elements in the set of predefined assessment criteria may include multiplying the score of each element in the set of predefined assessment criteria with the weight of the element of the predefined assessment criteria. The step may include normalising the final score to a percentage.

The method may include the step of allocating the normalised percentage into a predefined risk band. For example, the risk band may be defined as a score of between 0 and 50% resulting in a subject being a low risk, a score of between 51 and 80% resulting in a subject being a medium risk and a score of between 81 and 100% resulting in a subject being a high risk.

The invention extends to a social media presence analysis system, which includes

a social listener, operable to receive social media inputs streams;

a language analysis layer, operable to detect a foreign language in which text is received and to translate the language of text into English;

a structured database arranged to store the English text in a set of predefined data fields;

a natural language processor, operable to access data from the structured database and to analyse the language of the text in relation to a set of predefined assessment criteria;

a social media scoring engine, operable to receive inputs from the natural language processor and to calculate a score of a subject based on the subject's social media presence.

The score calculated by the social media score calculator may be indicative of a social media risk score of a subject.

The invention will now be described by way of a non-limiting example only, with reference to the following drawing.

### DRAWINGS

In the drawings:

FIG. 1 shows a broad overview of a method of allocating a score to a subject's Internet presence in accordance with one aspect the invention;

FIG. 2 shows an overview architecture of a social media presence analysis system in accordance with one aspect of the invention;

FIG. 3 shows operation of a social listener as part of the method of FIG. 1;

FIG. 4 shown operation of the data structuring and language translation layer as part of the method of FIG. 1;

FIG. 5 shows operation of the data file preparation for the scoring engine forming part of the method of FIG. 1;

FIG. 6 shows a functional block diagram of a scoring engine in accordance with the invention;

FIG. 7 shows schematically the importation of third party data as part of the method of FIG. 1;

FIG. 8 shows schematically a database in which the data generated as part of the method of FIG. 1 is stored;

FIG. 9 shows schematically examples of how the data generated by the scoring system can be analysed;

FIG. 10 shows data fields of the database of FIG. 8; and

FIG. 11 shows assessment of the data analysis illustrated in FIG. 9.

### EMBODIMENT OF THE INVENTION

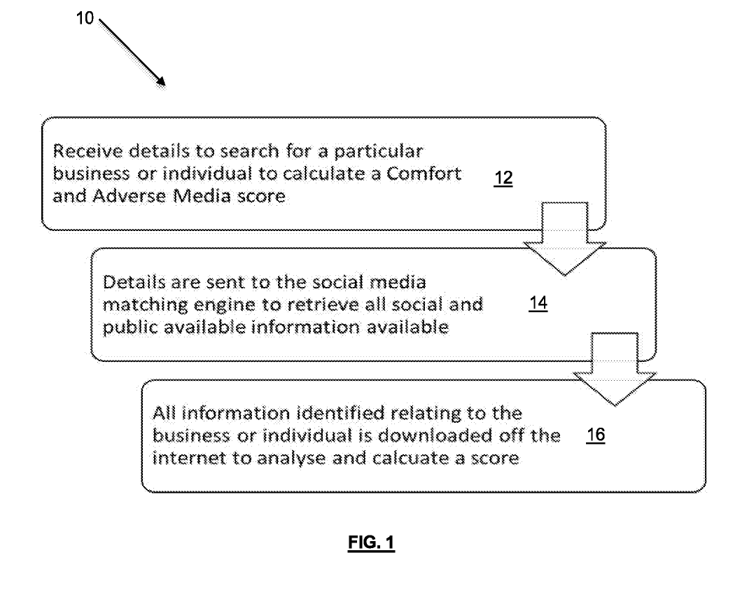

In FIG. 1, a broad overview (10) of a method of allocating a score to a subject's Internet presence is shown. In this example the subject's social media presence will be used to illustrate the invention. At (12) details of a particular subject is received which is to be scored. The subject can be a person or an entity. The search is conducted on the name of the subject and on other details that are available on the subject.

At (14) the details of the subject is forwarded to a matching engine to retrieve all data that is publicly available on the Internet and which is in one way or the other linked to any of the details of the subject. Typically the data that is publicly available may be social media information or other public data, such as white pages information, court procedure information,

At (16) data from the Internet matching the details of the subject supplied at 14 is retrieved onto a server and the data is analysed and a score is generated based on a predefined scoring algorithm.

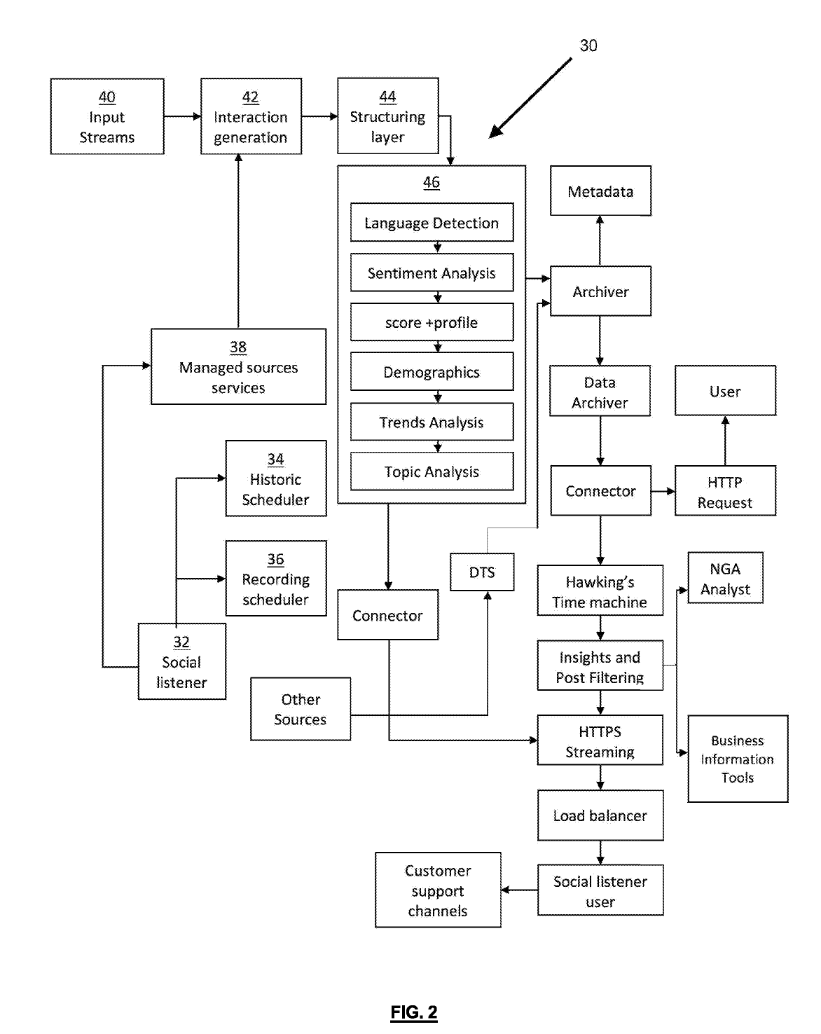

In FIG. 2 an overview architecture of a social media presence analysis system (30) in accordance with one aspect of the invention is shown. A social listener (32) is shown and is operable to receive information from a historic scheduler (34) and a recording scheduler (36). The input from the social listener (32) feeds to a managed sources services (38) from where the text feed is forwarded to an interaction generation stage (42). From the interaction generation stage (42) the text is feed to a structuring layer (44).

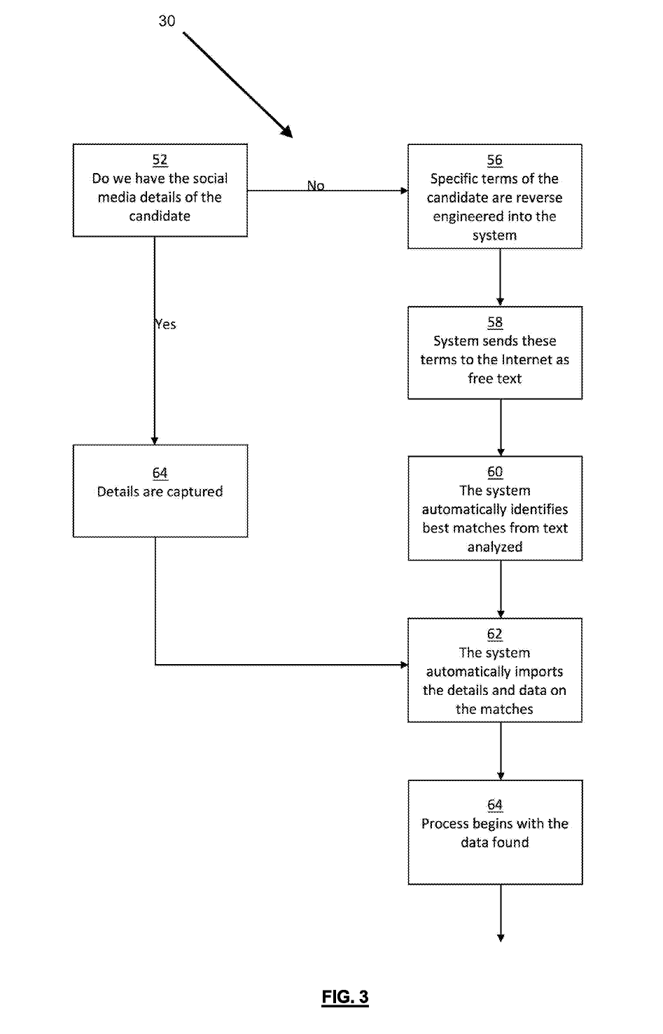

In FIG. 3 shows operation (50) of the social listener (32) as part of the method of allocating a score to a subject's social media presence (10), shown in FIG. 1.

At (52) an evaluation is done of whether the social media details of a subject has been received and whether the data is complete and sufficient. If the social media details have been received at (52) then the details are captured at (54). The social media details of the candidates can typically be a user or account name for a social media account, such as Twitter® account, Facebook® account, YouTube® account or the like.

If the social media details have not been received at (52) search terms are compiled from information that is available on the subject at (56). Search terms are chosen which best describe the candidate and are manually entered into the system. The system then generates an automatic search script by utilizing specific algorithms and search functions this generated profile script will be used to search for the candidate or organization under review or being assessed. The terms entered can include information such as identity number, name, surname, and name of employer, country of residence, job description or any other information that will provide the best match. At (58) the search terms are programmed into web crawlers to crawl the Internet for the search terms. The type of data searched can include any digital media such as text, video, images, photos, voice, eBook's, web pages, websites and the like.

From the data retrieved by the web crawlers, the terms that best matches the search terms compiled at (56) best are identified at (60). For example, a positive match is defined when more than 80% of the text searched match the text of the subject entered via the crawlers/API's. The match percentage can be adjusted to a lower percentage if no (or inadequate) matches are found be found or the match percentage can be adjusted to a higher percentage if too many results are identified.

At (62) the data associated with the search terms is imported into the social listener 32 along with text about the candidate that would be important for allocating a score.

At (64) all the data received from the Internet is prepared in a correct text format reading all the relevant information scraped/gathered on the terms searched for, for the person or organization searched for from the web and is normalized from an unstructured format into a structured format.

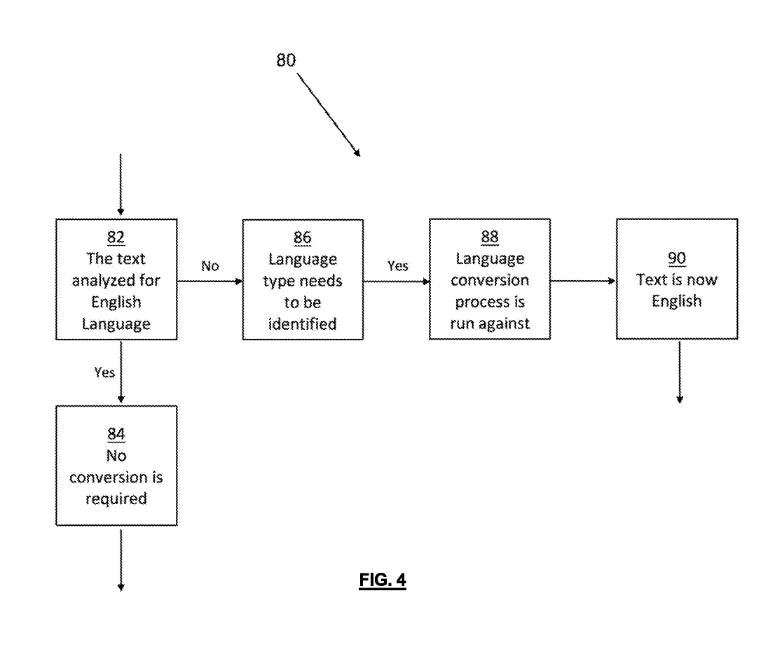

In FIG. 4 a flow diagram (80) illustrates how the data is translated into English by the data structuring and language translation layer. At (82) the text of the data is analysed and it is determined if the language is English. If the language is English execution directs to (84) and no translation of the text is needed. If at (82) it is determined that the text is not English, execution directs to (86) where the language is detected and the text is allocated a language identifier code. For example, the following language examples can be used:

| | | | | | |
|---|---|---|---|---|---|
| af | Afrikaans | hr | Croatian | el | Greek |
| pl | Polish | sx | Sutu | sq | Albanian |
| cs | Czech | gu | Gujurati | pt | Portuguese |
| sw | Swahili | ar | Arabic | da | Danish |
| | | | (Standard) | | |
| ht | Haitian | pt-br | Portuguese | sv | Swedish |
| | | | (Brazil) | | |
| ar-dz | Arabic | nl | Dutch | he | Hebrew |
| | (Algeria) | | (Standard) | | |
| pa | Punjabi | sv-fi | Swedish | ar-bh | Arabic |
| | | | (Finland) | | (Bahrain) |
| nl-be | Dutch | hi | Hindi | pa-in | Punjabi |
| | (Belgian) | | | | (India) |
| sv-sv | Swedish | ar-eg | Arabic | hu | Hungarian |
| | (Sweden) | | (Egypt) | | |
| pa-pk | Punjabi | ta | Tamil | | |
| | (Pakistan) | | | | |

At (88) the system uses the language identifier code allocated by the system automatically to connect the text field to the correct Language dictionary for conversion into English. At (90), the text is translated into English.

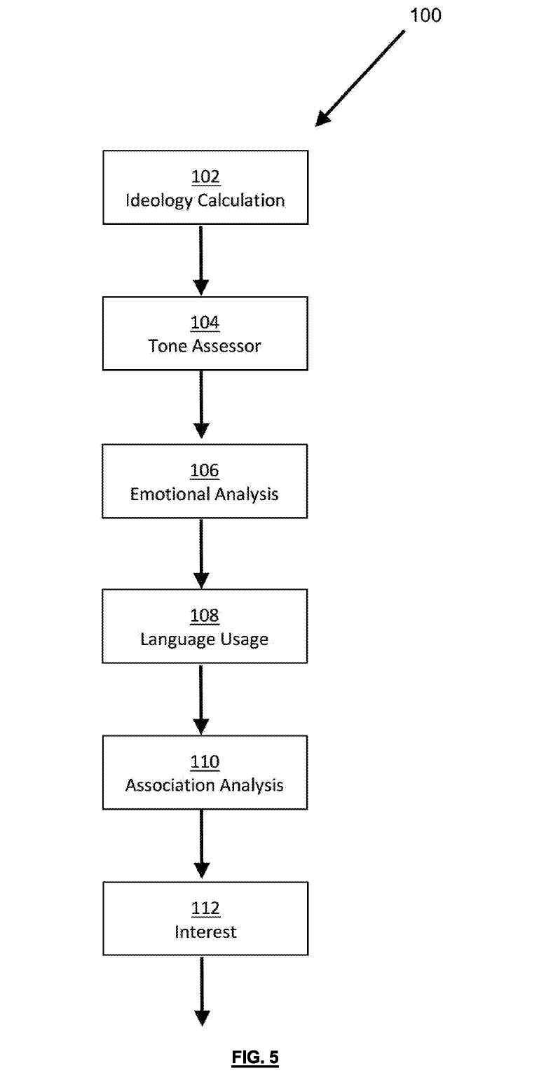

FIG. 5 shows operation of the data file preparation for the scoring engine in a flow diagram (100). The data file preparation forms part of the method of FIG. 1. At (102) the English text is received from the data structuring and language translation layer following the method shown in FIG. 4. The scoring engine makes use of natural language processing (NLP) to extract language information from the English text by using predefined dictionaries and templates specific to the aspect being analysed from the text. These dictionary and templates are continuously being updated and enhance via automated online analysis gathering techniques relevant to the various scoring aspects. This ensures that the dictionaries remain relevant and up-to-date to ensure accuracy for analysis.

At (102) the ideology of the subject is determined by analysing words used by the subject to determine whether the person is Conservative, Right Wing, Left Wing, Mixed Ideology, Christiaan, Communist Nazi, Anti EU, American Baptist, Anti-Corruption etc. For example, certain words would be associated with each of the ideologies, such as Christiaan—God loving, Peaceful, Lord, Amen, Psalm, Congregation, forgiveness, etc
Right Wing—supremacy, Domination, Extremist, controlled, conventional, die-hard, brotherhood, radical

At (104) the tone of the text is analysed to determine whether the subject has an aggressive, passive, impatient, irritated or normal tone etc. For example, certain words would be associated with a different tone, such as

Positive—Loving, Affectionate, Amorous, tolerant
Negative—Tentative, Indifferent, pessimistic, detached, Depressed, Disturbed, Perturbed, Cynical

At (106) the text is analysed to implement an emotional analysis algorithm to determine the current state of the subject. For example, subject's emotional state will be categorized into categories such fear, disgust, sadness, joy, anger etc. For example, certain words would be associated with an emotional state such as:

| Joyful | Tenderness | Helpless |
|---|---|---|
| Confident | Anticipating | Hurt |
| Brave | Eager | Lonely |
| Comfortable | Hesitant | Regretful |
| Safe | Fearful | Depressed |

At (108) the text is analysed to categorize the language as being pacifistic, radical, political, bad language, vulgar, sexual, harassment, racial, sexiest etc. For example, certain words would be associated with a certain category of language such as

### Vulgar or Sexual Language:

motherfucking
motherfuckings
motherfuckka
motherfucks
lmfao
m0f0
m0fo
m45terbate
ma5terb8
ma5terbate
masturbate

At (110) the connections to the subject on social media is analysed. For example, a list is compiled containing people, organizations, countries, and the like with which the subject is linked or communicates with.

At (112) the text is analysed to determine the interests of the subject, such as soccer, travel, fishing, rugby, cooking, music, reading, cars, or the like.

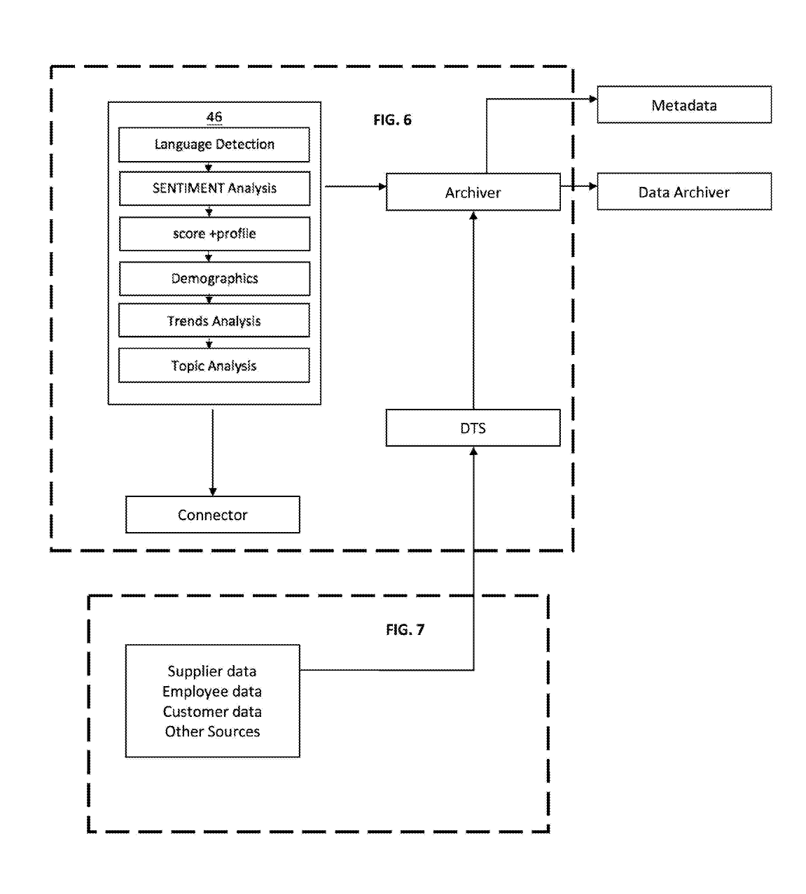

The flow diagram terminates at (112) from where the information calculated from the various scoring aspects listed in (102) to (112) is now forwarded to the scoring engine (46) in FIGS. 2 and 6. It is to be appreciated that not all the above factors listed in (102) to (112) need be included in determining the social media presence score. In various embodiments of the invention, the formula for determining the social media presence score, as well as the lower threshold value that may be used to determine whether an activity indicator is displayed, will vary.

FIG. 6 shows a functional block diagram of a scoring engine (46). It is to be appreciated that the description below provides mere examples of how a score can be generated.

The parameters used to calculate the social media presence score are shown below:

| | |
|---|---|
| Factor | Scores are calculated based on pre-defined factors ex. |
| | Ideology, Emotions, Associations, Language, Interests, Tone. |
| Factor | Each of the Score factors will be assigned a certain weight to |
| Weight | indicate the importance of the factor in the overall risk score. |
| Factor | Each factor is assigned a factor value being High(H), |
| Values | Medium(M) and Low(L) |
| | For example: For the Ideology factor a subject will be |
| | assigned a risk. Right Wing = 3, Left Wing = 1, Mixed |
| | Ideology = 2, Christiaan = 1, Communist Nazi 3, Anti EU = |
| | 3 etc. |
| Factor | Factor Points are assigned based on the Factor Risk: |

| | |
|---|---|
| Points | Low Risk = 1 point |
| | Medium Risk = 2 points |
| | High Risk = 3 points |

| | |
|---|---|
| Customer | The Comfort risk percentage is calculated as follows: |

| | |
|---|---|
| risk | For each factor the customer's risk score is multiplied by |
| Percentage | the weight |

(Factor Value Risk Score * Weight)

The results of each factor are added together to get an
overall score
The overall score is divided by 3 (maximum number of
points per factor) to get a percentage

| | |
|---|---|
| Risk | Risk Bands will be specified between 0 and 100. The |
| Bands | customer risk percentage will be compared to the Risk Bands |
| | to identify the customer's overall risk. |

The factors can each be weighted as shown below:

| Factor | Weight |
|---|---|
| Ideology | 20 |
| Language | 35 |
| Interest | 20 |
| Associations | 15 |
| Tone | 10 |
| Total | 100 |

Note:
The total of the individual Factor weights should always equal 100

The factors can each be valued as follows:

| FACTOR | FACTOR VALUE | FACTOR RISK |
|---|---|---|
| | Reform | L |
| | social-democratic | L |
| | Roman Catholic Church | L |
| | Republican National | M |
| | religious right | H |
| | Right wing | M |
| | rightwing Nazi | H |
| Language | AMAZING | L |
| | BITCH | M |
| | CRAP | H |
| Interest | Cricket | L |
| | Education | L |
| | Murder | H |
| | Porn | H |
| | Violence | H |
| Language | Pacifistic | L |
| | Radical | M |
| | Racial | H |

Risk bands can be defined as follows:

| | | | | | | | | | | |
|---|---|---|---|---|---|---|---|---|---|---|
| 0 | 10 | 20 | 30 | 40 | 50 | 60 | 70 | 80 | 90 | 100 |

where

Between 0 and 50% a customer is LOW RISK

Between 51 and 80% a customer is MEDIUM RISK

Between 81 and 100% a customer is HIGH RISK

The operation of the score calculator is shown in the two examples below:

### Example 1

Candidate is Right Wing

He uses the words “kill” and “hate” a lot

He is very interested in Nazi movements

He is a member of the local Nazi association

His tone is very aggressive

| | | | FAC- | | |
|---|---|---|---|---|---|
| FAC- | | FACTOR | TOR | CALCULA- | |
| TOR | WEIGHT | VALUE | RISK | TION | SCORE |
| Ideology | 20 | Right Wing | High (3) | 3 * 20 | 60 |
| Language | 35 | Hate and | High (3) | 3 * 35 | 105 |
| | | Kill | | | |
| Interest | 20 | Nazi | High(3) | 3 * 20 | 60 |
| | | Movement | | | |
| Associ- | 15 | Nazi | High(3) | 3 * 15 | 45 |
| ations | | Association | | | |
| Tone | 10 | Aggressive | High(3) | 3*10 | 30 |
| TOTAL | 100 | | | | 295 |

After an overall score for the subject has been determined, the score is divided by 3 (max points per factor)

### For Candidate Y: 295/3=98.3

Using the Risk Bands, this person will be High Risk as his score is higher than 80%

### Example 2

Candidate is Democratic

She uses peaceful words like “love” and “sharing” a lot

She is very interests in Environmental issues

She is a member of the save the dog foundation

Her tone is very peaceful

| | | | FAC- | | |
|---|---|---|---|---|---|
| FAC- | | FACTOR | TOR | CALCULA- | |
| TOR | WEIGHT | VALUE | RISK | TION | SCORE |
| Ideology | 20 | Democratic | Low (1) | 1 * 20 | 20 |
| Language | 35 | Love and | Low (1) | 1 * 35 | 35 |
| | | sharing | | | |
| Interest | 20 | Environmental | Low (1) | 1 * 20 | 20 |
| Associ- | 15 | Save the dog | Low (1) | 1 * 15 | 15 |
| ations | | foundation | | | |
| Tone | 10 | Peaceful | Low (1) | 1*10 | 10 |
| TOTAL | 100 | | | | 100 |

After an overall score for the subject has been determined, the score is divided by 3 (max points per factor)

### For Candidate X: 100/3=33.3

Using the Risk Bands, this person will be LOW RISK, as her score fall below 50%.

As illustrated schematically in FIG. 7, any third-party data (130) can be imported into the score calculator for analysis. The data could be supplier data, employee data, or customer data. The data allows batch imports of many records to be imported at a time. Once imported the data will be entered into the search engine automatically to be matched to data in social media channels and the Web in the same manner as when you perform a manual search.

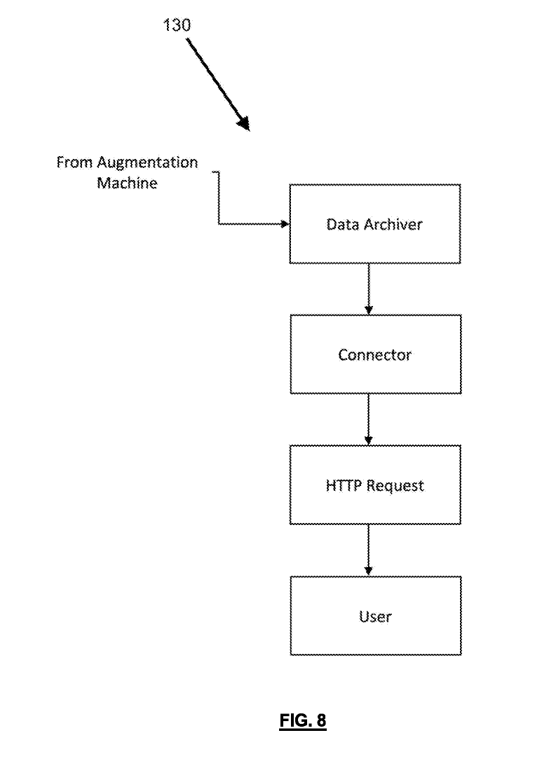

FIG. 8 shows schematically a database (130) in which the data generated as part of the method of FIG. 1 is stored. Data fields of the database is further illustrated in FIG. 10.

All the data generated in the method of allocating a score to a subject's social media presence is stored in the database (130) in the data fields indicated in FIG. 10. Field (150) stores a unique system identifier, field (152) stores the source where the information was found, such as news, blogs, forums, websites, radio, social media sites, and the like. Field (154) stores a subject identifier such as name, social media account, identity number, physical address, mobile number, employer details, and the like. Field (156) stores information extracted from the source which the information in the subject identifier search best matched too. Field (158) stores the ideology allocated to the subject following analysis of the text, such as right wing, conservative, left wing, mixed ideology, Christian, communist nazi, anti-EU, American Baptist, Anti-corruption, and the like. Field (160) stores the emotional score of the subject such as happy, sad, nervous, worried, cross and the like. Field (162) stores the language usage score such as foul, offensive, profanity, bad words, swear words, political, sexual, racial and the like. Field (164) stores entities or individuals with which the subject is associated. Field (166) stores the tone that the subject uses, such as appreciative, ardent, arrogant, bitter, compliant, critical, confused, condescending and the like. Field (168) stores the interests of the subject such as aircraft spotting, airbrushing, airsoft, acting, aeromodelling, amateur astronomy, amateur radio, animals/pets/dogs, archery, soccer, judo, base jumping, basketball beach/sun tanning, beachcombing and the like.

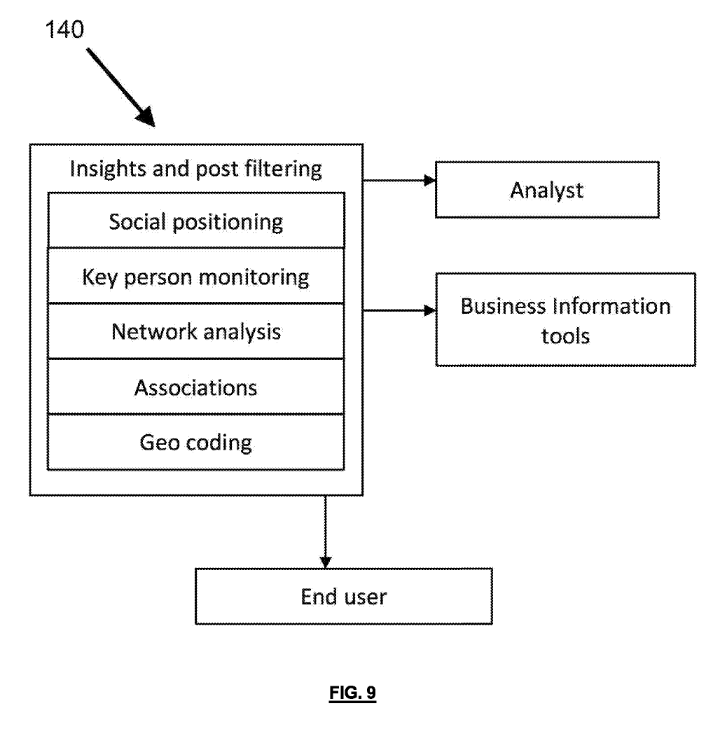

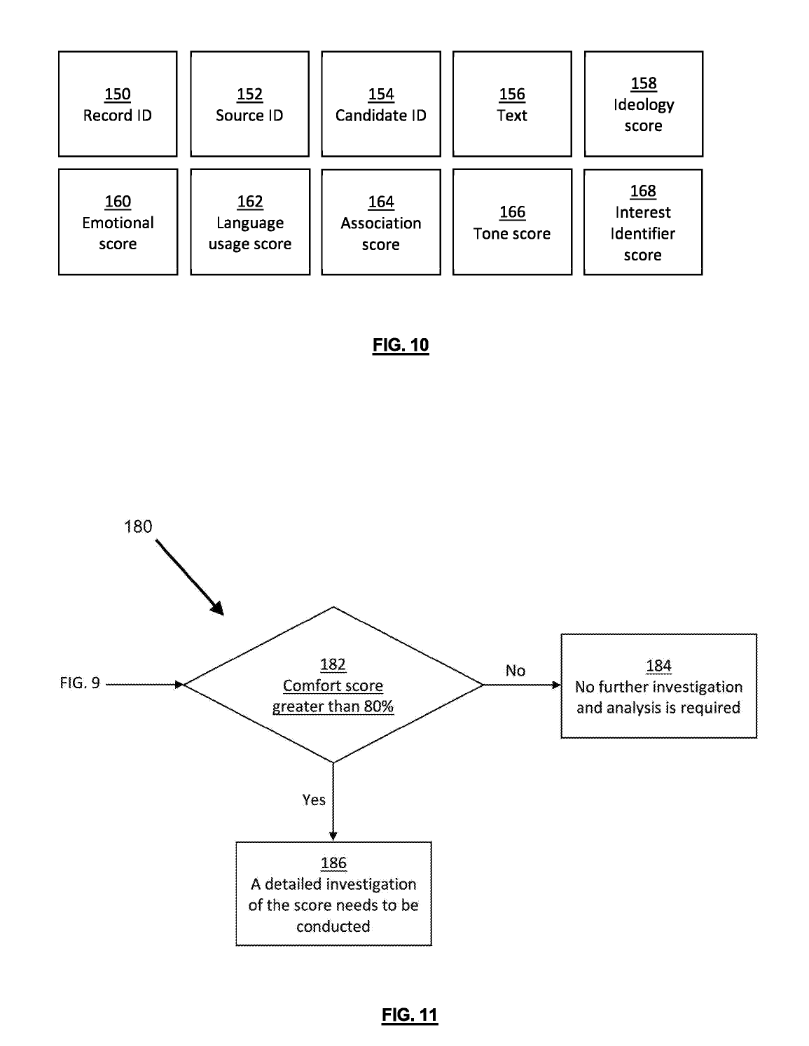

FIG. 9 shows schematically examples of how the data generated by the scoring system can be analysed and operation of the data analysis is further illustrated in FIG. 11.

FIG. 11 shows assessment of the data analysis illustrated in FIG. 9. As set out above, a user of the social media presence analysis system can search for subjects who meet various search requirements as set out in FIG. 3 above. For example an employer searching for a potential employee as subject may enter an appropriate search query and launch a search as set out in (58) and (60) of FIG. 3. One or more of the search targets found as part of the search may then be displayed to the searcher via the application (140) as shown in FIG. 9. FIG. 9 schematically illustrates the application that performs the searches and view the results of the search. The application is an easy to use Graphical User Interface (GUI) that performs the method set out in FIG. 3. The search results generated by the application (140) may include summary information about each target matching the search criteria and targets may be sorted by one or more factors. Some factors may include a score, such as a risk score. The user of the application (140) may also be provided the option to view a full or a partial profile of any target's information.

The application further provides a comparative method of scoring to establish a comparative baseline against which profiles can be evaluated. The comparative method of scoring may be used to eliminate scores that are significantly out of line with other comparable scores. All search data can be displayed to a user of the social media presence analysis system.

The social media presence analysis system, and in particular the application (140) can be integrated with other applications to retrieve additional information of a subject into the social media presence analysis system such as a payroll system, a supplier database, a customer database or an employee system.

The social media presence score may be used by the application (140) as a search field in itself. For example, a user of the social media presence analysis system may request a listing of all subjects that exceeds or lies below certain predefined social media threshold.

The inventor is of the opinion that the method of allocating a score to a subject's Internet presence provides a novel method of assessing a risk associated with various dealings in which a subject is potentially involved in, such as employment, credit rating and the like. Similarly the social media presence analysis system provides a new system which can be employed to assess a risk associated with a subject's social media presence.

1-28. (canceled)

29. A method of allocating a score to a subject's Internet presence, the method including
receiving search terms of a subject whose Internet presence is to be scored;
conducting Internet searches by employing any one of web crawlers, RSS feeds and Application program interfaces (API's) systematically to return text found on the Internet which includes the search terms that are searched, thereby to compile preliminary search results of websites on which the search terms appear;
assessing the preliminary search results to confirm that the preliminary search results exceed a predefined minimum match threshold with the search terms;
compiling final search results from the preliminary search results that exceeds the predefined minimum match threshold;
compiling the final search results in a structured database;
assessing the text of the final search results in the structured database in relation to a set of predefined assessment criteria;
allocating a score to each element in the set of predefined assessment criteria according to a predefined scoring scheme; and
compiling a final score of a subject's presence on websites by collating the scores of each of the elements in the set of predefined assessment criteria.

30. The method of claim 29, in which the websites that are searched include social media sites and the final score of the subject's presence on websites thus refers to the subject's presence on social media sites.

31. The method of claim 30 in which receiving search terms of a subject whose social media presence is to be assessed includes receiving usernames of a subject's social media accounts.

32. The method of claim 30 in which receiving search terms of a subject whose social media presence is to be assessed includes compiling a list of social media search terms based on a subject's personal details.

33. The method of claim 30 in which personal details of a subject includes the subject's name, surname, nicknames, interests, hobbies, country, people and organizational associates, profession current and past, location and employer.

34. The method of claim 30 which includes translating the final search results from a foreign language into the English language.

35. The method of claim 34 which includes detecting the foreign language and then applying a translation application to translate the text from the foreign language into English.

36. The method of claim 30 in which the step of assessing the preliminary search results to confirm that the preliminary search results exceed a predefined minimum match threshold includes comparing the text found with the set of search terms searched for and compiling a correlation score between the search terms and the search results.

37. The method of claim 30 in which the set of predefined assessment criteria includes the ideology of the subject, the tone used by the subject, the emotional expression of the subject, the language used by the subject, the associations of the subject and the interests of the subject.

38. The method of claim 30 in which the step of compiling the final search results in a structured database includes arranging the text of the search results into fields in a database.

39. The method of claim 38 in which the fields in the database contains a set selected from the following fields: an unique system identifier, a source where the information was found, a subject identifier, information extracted from the source, an ideology allocated to the subject, an emotional score of the subject, a language usage score, entities or individuals with which the subject is associated, a tone that the subject uses and interests of the subject.

40. The method of claim 30 in which the step of assessing the text of the final search results in the structured database in relation to a set of predefined assessment criteria includes categorizing the language used in the text into a number of predefined alternatives for at least some of the fields in the database.

41. The method of claim 30 in which the step of allocating a score to each element in the set of predefined assessment criteria according to a predefined scoring scheme includes allocating a numerical value to the results of each element in the set of predefined assessment criteria.

42. The method of claim 30 in which the step of allocating a score to each element in the set of predefined assessment criteria includes associating a weight element to each of the predefined assessment criteria.

43. The method of claim 30 in which the step of compiling a final score of a subject's social media presence by collating the scores of each of the elements in the set of predefined assessment criteria include multiplying the score of each element in the set of predefined assessment criteria with the weight of the element of the predefined assessment criteria.

44. The method of claim 43 which includes normalising the final score to a percentage.

45. The method of claim 44 which includes the step of allocating the normalised percentage into a predefined risk band.

46. The method of claim 45 in which the risk band is defined as a score of between 0 and 50% resulting in a subject being a low risk, a score of between 51 and 80% resulting in a subject being a medium risk and a score of between 81 and 100% resulting in a subject being a high risk.

47. A social media presence analysis system, which includes
a social listener, operable to receive social media inputs streams;
a language analysis application operable to detect a foreign language in which text is received and to translate the language of the text into English;
a structured database arranged to store the English text in a set of predefined data fields;
a natural language processor, operable to access data from the structured database and to analyse the language of the text in relation to a set of predefined assessment criteria;
a social media scoring engine, operable to receive inputs from the natural language processor and to calculate a score of a subject based on the subject's social media presence.

48. The method of claim 47 in which the score calculated by the social media score calculator is indicative of a social media risk score of a subject.
